(19) United States
(12) Patent Application Publication
(10) Pub. No.: US 2008/0151055 A1
(43) Pub. Date: Jun. 26, 2008

(54) SURVEILLANCE APPARATUS, SYSTEM, AND METHODS OF CONSTRUCTING AND UTILIZING SAME

(76) Inventor: PERRY ELSEMORE, Saxon, WI (US)

Correspondence Address: Irving M. Weiner;Weiner & Burt, P.C., 635 N. US-23, P.O. Box 186, Harrisville, MI, 48740, US

(21) Appl. No.: 11/956,063

(22) Filed: Dec. 13, 2007

Related U.S. Application Data
(63) Continuation-in-part of application No. 29/275,293, filed on Dec. 20, 2006.
Application No. 29/275,293 is a continuation-in-part of application No. 29/283,278, filed on Aug. 9, 2007.
(60) Provisional application No. 60/870,952, filed on Dec. 20, 2006.

(51) Int. Cl. H04N 7/18

(52) U.S. Cl. 348/155; 348/E07.085; 348/E07.086; 348/E07.09

(57) ABSTRACT

A digital image recording surveillance apparatus and system for 24-hour home or business security, surveillance, or to monitor and detect animal movement. The apparatus has a camera, which when activated, photographs an object entering a heat-in-motion detection zone.

### CROSS-REFERENCE TO RELATED APPLICATIONS

The present application is a continuation-in-part of and claims priority from U.S. Provisional Patent Application Ser. No. 60/870,952 filed Dec. 20, 2006; U.S. Design patent application Ser. No. 29/275,293 filed Dec. 20, 2006; and U.S. Design patent application Ser. No. 29/283,278 filed Aug. 9, 2007; the entire contents of which applications are incorporated herein by reference thereto.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to a novel and unique surveillance apparatus, system, and methods of constructing and utilizing same.

More particularly, the present invention relates to a surveillance apparatus system using a 360 degree dome mounted camera, and methods of constructing and utilizing same.

In the surveillance industry, including but not limited to home and/or business surveillance and animal/game/trail surveillance, the conventional fixed board mounted cameras can detect only motion up to approximately 120 degrees, and are not capable of rotating or any movement whatsoever.

The prior, but not necessarily relevant, art is exemplified by:

Nakamura U.S. Pat. No. 5,133,605;

Smoot U.S. Pat. No. 5,940,139;

Midgley et al. U.S. Pat. No. 6,642,955;

Huster United States Patent Application Publication 2005/0212912;

Lungershausen et al. U.S. Pat. No. 5,701,015;

Olczak et al. U.S. Pat. No. 6,275,256; and

Park US Patent Application Publn. US2007/0019077.

The present invention solves the aforementioned problems and other problems, and also provides an apparatus and system which can be used full-time under all types of light conditions, day and night.

It is a desideratum of the present invention to avoid the animadversions of the conventional and present techniques and systems, and to provide a very energy-efficient surveillance apparatus and system.

### SUMMARY OF THE INVENTION

The invention provides a surveillance system, comprising: one or more wireless remote sensors which each send an infrared transmission signal configured into a separate conical array forming a heat-in-motion detection zone; a surveillance apparatus having a 360-degree dome mounted camera; wireless transmission means for transmitting a signal from said remote sensor to said apparatus indicative of an external object entering said detection zone; and means in said apparatus causing said camera to rotate to face in the direction of the object and to photograph the object.

The invention also provides a self-contained surveillance apparatus, comprising: a water-tight case; a 360-degree dome camera mounted in said case; a digital imaging engine mounted in said case; a battery supply mounted in said case; one or more infrared diodes mounted in said case; one or more passive infrared sensors mounted in said case; a wireless circuitboard antenna mounted in said case; a mass storage device mounted in said case; a day/night exchanger mounted in said case; a compact flash card mounted in said case; and said digital imaging engine being operably connected to said camera, said battery supply, said infrared diodes, said passive infrared sensors, said antenna, said mass storage device, said day/night exchanger, and said compact flash card; and whereby said camera is caused to rotate to face in the direction of an external object to be photographed by said camera.

Another embodiment of the invention provides a self-contained surveillance apparatus that does not require remote sensors, comprising: a water-tight case; a camera mounted in said case; a digital imaging engine mounted in said case; a battery supply mounted in said case; one or more infrared diodes mounted in said case; one or more passive infrared sensors mounted in said case; a light sensor mounted in said case; a wireless circuitboard antenna mounted in said case; a mass storage device mounted in said case; a day/night exchanger mounted in said case; a compact flash card mounted in said case; and said digital imaging engine being operably connected to said camera, said battery supply, said infrared diodes, said passive infrared sensors, said antenna, said mass storage device, said day/night exchanger, and said compact flash card; and whereby said camera is enabled to take a photographic image of an external object entering a heat-in-motion detection zone.

The present invention provides a surveillance system which, in one embodiment, includes a 360-degree dome mounted camera.

The present invention provides a digital image recording system and apparatus for 24-hour home or business security, surveillance, and to monitor and detect animal movements.

It is a primary object of the present invention to provide a game/trailcam wildlife surveillance system, as described hereinbelow, which provides a complete 360-degree detection zone.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a rear perspective view of a self-contained surveillance apparatus/system in accordance with a first embodiment of the present invention.

FIG. 2 is a side elevational view as viewed from the right of the apparatus as depicted in FIG. 1.

FIG. 3 is a front elevational view thereof.

FIG. 4 is a side elevational view as viewed from the left of the apparatus as depicted in FIG. 1.

FIG. 5 is a rear elevational thereof.

FIG. 6 is a top plan view thereof.

FIG. 7 is a bottom view thereof.

FIG. 8 illustrates a second embodiment of the invention.

FIG. 9 is a composite schematic block diagram for explaining the interconnection system for using various embodiments of the invention

FIG. 10 is a front perspective view of a self-contained surveillance apparatus/system in accordance with a third embodiment of the present invention that does not require remote sensors.

FIG. 11 is a front elevational view of the FIG. 10 apparatus.

FIG. 12 is a rear perspective view of the FIG. 10 apparatus.

FIG. 13 is a right side elevational view of the FIG. 10 apparatus.

FIG. 14 is a rear elevational view of the FIG. 10 apparatus.

FIG. 15 is a schematic diagram of a wireless transmitter and some portions of the other embodiments.

### DETAILED DESCRIPTION OF THE INVENTION

The present invention provides a digital image recording surveillance apparatus and system for 24-hour home or business security, surveillance, and/or to monitor and detect animal movement.

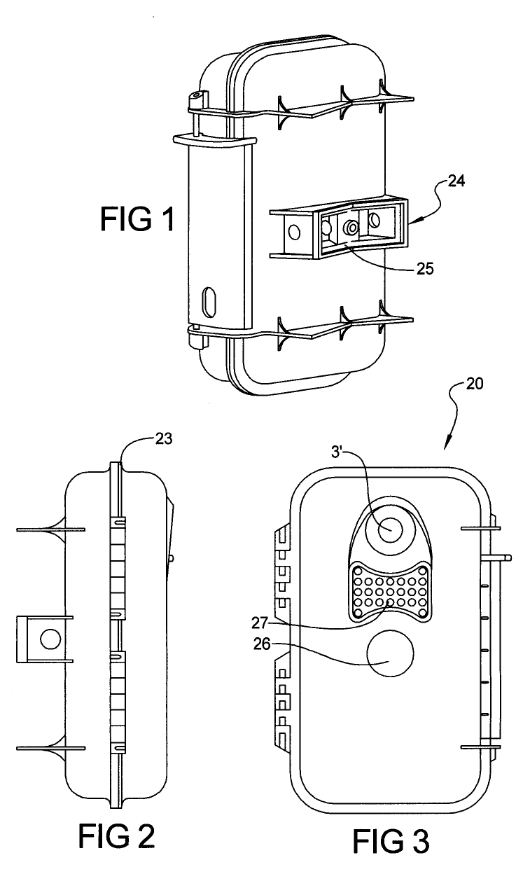

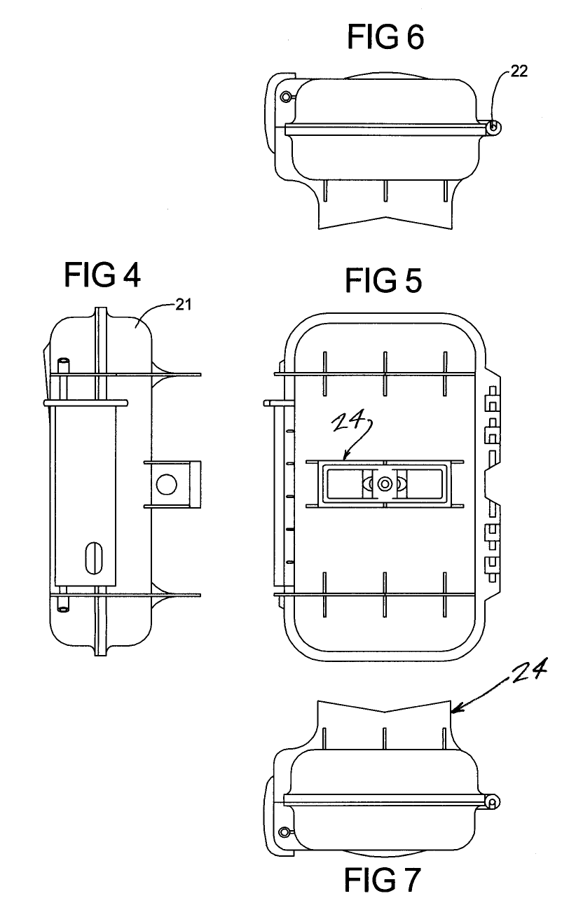

FIGS. 1-7 illustrate a self-contained surveillance system/apparatus 20 in accordance with a first embodiment which may readily be mounted on an external structure, for example, on a tree.

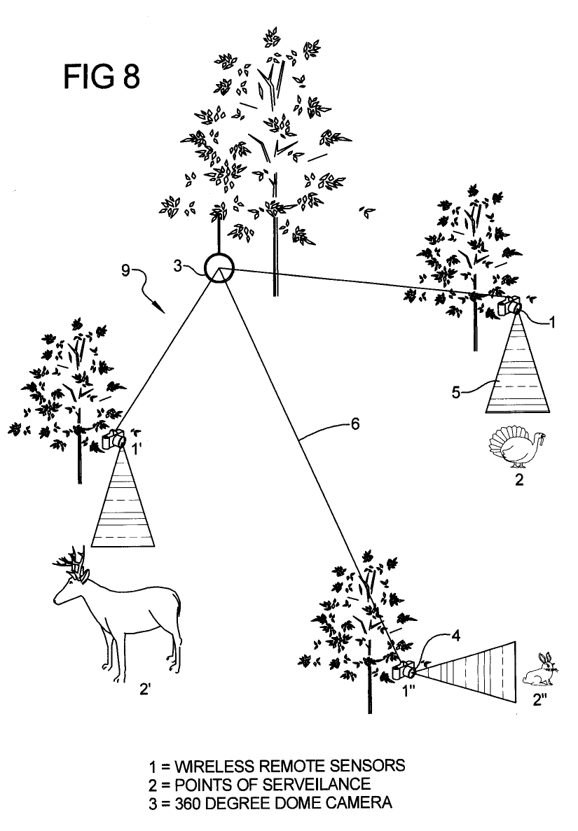

FIG. 8 illustrates a system 9 in accordance with a second embodiment which uses a 360-degree dome camera 3 and wireless remote sensors 1, 1′ and 1″ in the vicinity of points of surveillance 2, 2′ and 2″, respectively.

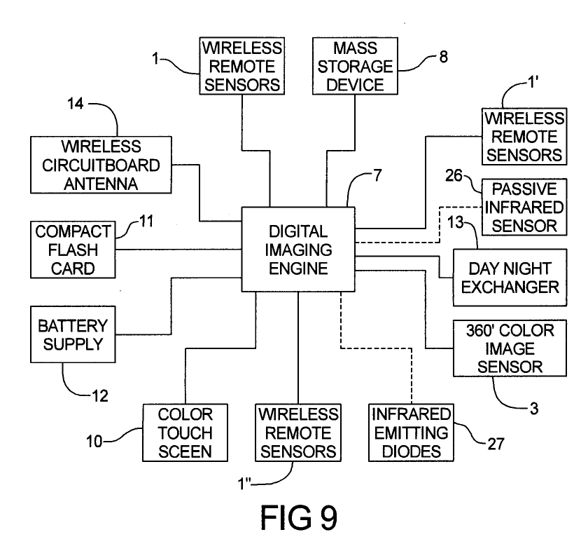

The first and second embodiments employ many similar components which will become apparent from the detailed description, especially with regard to composite block diagram of FIG. 9.

It is perhaps easier to understand the features of the invention by first considering FIGS. 8 and 9.

Each wireless remote sensor 1, 1′ and 1″ sends an infrared transmission signal through a lens 4. Preferably, but not necessarily, the lens 4 may be a Fresnel 0.65 piano convex 0.015 thick poly lens.

The signal is thereby configured into an 80-degree conical array which is the heat-in-motion detection zone 5. When heat radiation in motion (which may be caused by, for example, a person or an animal) enters this detection zone 5, a RF communication signal 6 is sent from a remote sensor antenna of the wireless remote sensor 1, 1′ or 1″ to a wireless circuit board antenna 14. This signal then dictates the direction of the object to be photographed, and causes the 360-degree color image sensor or dome mounted camera 3 to rotate to face in the direction of the object and photograph it.

Clear crisp images are received through an optional 1× to 4× (power) optics wide angle lens high-resolution lens. Preferably, but not necessarily, these optional lens assemblies may be threaded into a Sunex M12-EXM-IRC21 miniature day/night exchanger 13 that covers an OV7710 VGA ¼ color image sensor along with exchanger 13 which permits the taking of true day/night photographs.

Preferably, but not necessarily, the image is sent through the Omni Vision OV7710 VGA ¼ format color low-light 0.04 lux image sensor.

Preferably, but not necessarily, the images and video are then processed by a Vista Imaging ViCam III digital imaging engine or processor 7. These images are then sent and stored into a mass storage device (USB) 8 where they can be viewed and edited when desired. The mass storage device(s) may include, but are not limited to, a compact flash card or an USB jump drive. The USB mass storage device 8 is preferred, and is uniquely used as a host and not as a slave. This means that it can store information, still photographs, and/or video, and then be plugged directly into an USB port of a computer to download the stored information, etc.

The system 9 is preferably provided with a color touch screen 10 which can be used to view photos, video, pan, tilt and digitally zoom, and can also be used to set and control all the system functions and settings stored and given from the digital imaging engine (processor) 7 by touching selected grid areas within the color touch screen 10.

The digital imaging engine or processor 7 also controls and selects which device the images will be stored in. One option which is most preferred is the USB mass storage device (jump/flash drive) port. The other storage device which is secondary is a compact flash card (CF) 11.

The engine 7 also: signals and controls the day/night exchanger sensor 6 for night and day photos; sends information to and receives commands from the color touch screen 10; and receives signals from the wireless remote sensors 1, 1′ and 1″.

A battery supply 12 furnishes power to the camera 3 and other components.

With reference to FIGS. 1-6, there is shown a self-contained surveillance apparatus/system 20. The apparatus 20 is complete and ready for mounting, for example, on a tree or post. Preferably, but not necessarily, the apparatus 20 may be camouflaged.

The apparatus 20 includes a water-tight case 21 with a hinge 22 and a gasket 23. Most of the components described above with reference to FIG. 8 are enclosed within the case 21.

The rear side of the apparatus 20 is provided with a V-shaped locking structure 24 including special brackets 25 to facilitate its mounting. The locking structure 24 serves as a portable/moveable locking device for securing the apparatus 20 to an external object, such as tree or post.

As shown in FIGS. 3 and 9, the apparatus 20 is provided with a passive infrared sensor 26 and infrared emitting diodes 27. The passive infrared sensor 26 emits a constant signal beam, and senses heat in motion. When this occurs, the passive infrared sensor 26 signals the digital imaging engine 7 to activate the infrared emitting diodes 27 to illuminate the object only if it is dark, and have the color image sensor/camera 3′ orient itself in the direction of the object and photograph it. Thus, the passive infrared sensor 26 detects heat in motion, which in turn signals the camera 3′ and allows it to take clear photos of the object which is generating the heat in motion

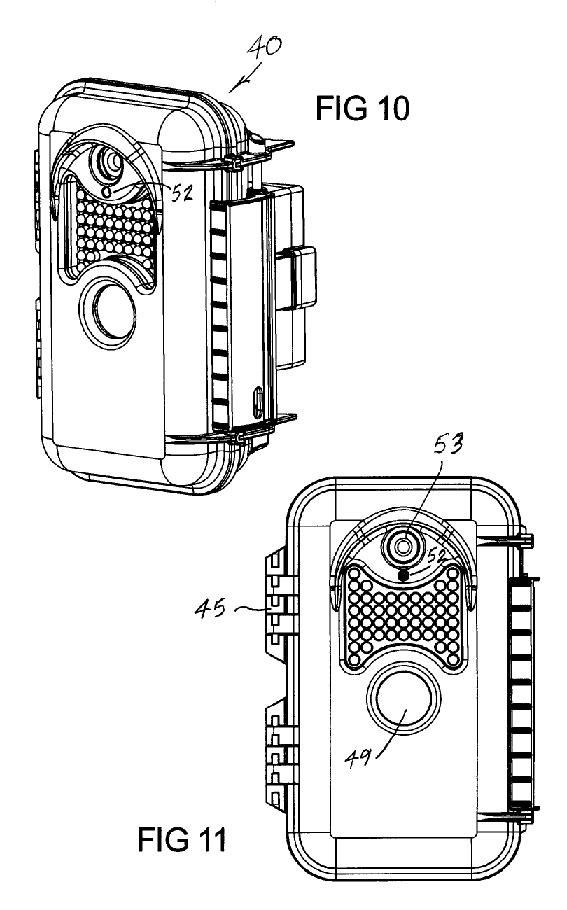

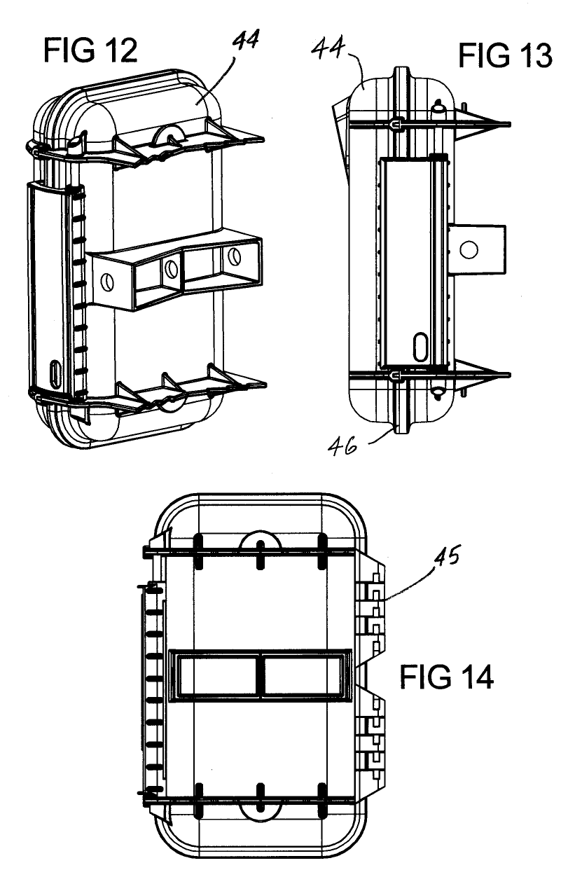

Preferably, but not necessarily, the system/apparatus 20 shown in FIGS. 1-7 may use 24 infrared emitting diodes (IEDs). These diodes may be of 940 nm type which is very high frequency and emit no visible red light. These are excellent for security, and they do not alert animals that there is a camera in the area. However, a draw-back is that the distance is limited to approximately 30 feet. Some users favor/demand the stealth no-light IEDs, but other users favor/demand a system/apparatus which accomplishes “seeing” more distance even it means using a lower IED that emits some visible red light. The system/apparatus 40 shown in FIGS. 10-15 satisfies both of the aforementioned demands.

The system/apparatus 40 adds 24 more infrared emitting diodes 41 of a lower frequency in the 830 nm range. These diodes 41 will emit some visible light. These diodes 41 are mixed in with the 940 nm diodes 42 which emit no visible light, using two different circuits. One circuit operates the 830 nm diodes 41, and another circuit operates the 940 nm diodes 42.

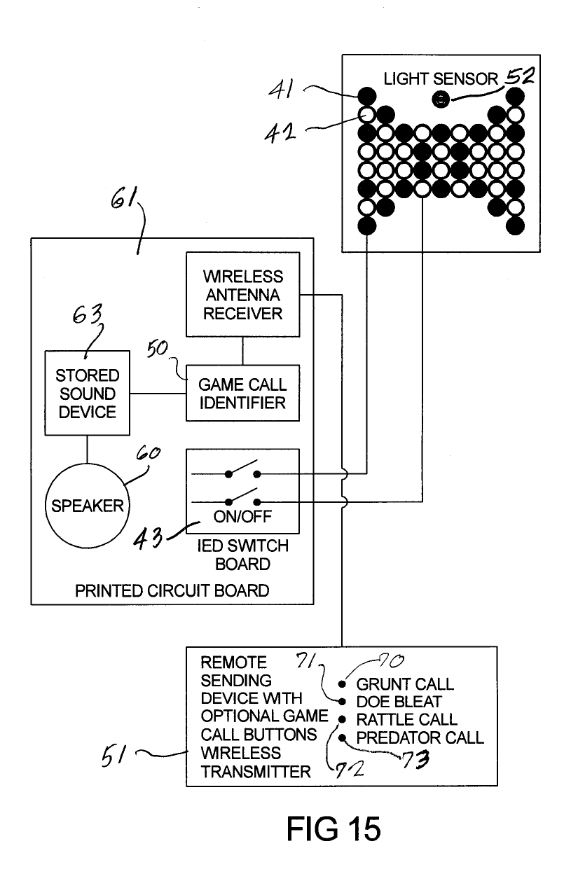

This arrangement gives the user the option using no visible light by activating only the 940 nm diodes 42, or if the user wants the extended distance of approximately 60 feet, then the user an operate both the 940 nm diodes 42 and the 830 nm diodes 41 at the same time via a switch 43 (see FIG. 15) in the system.

The apparatus 40 of FIGS. 10-14 is similar in certain respects to the apparatus 20 shown in FIGS. 1-7. One difference is a case change to the front half of the apparatus to accommodate the mixed IED arrangement described hereinabove.

With reference to FIGS. 10-14, there is shown the self-contained surveillance apparatus/system 40 which does not require remote sensors. The apparatus 40 is complete and ready for mounting, for example, on a tree or post. Preferably, but not necessarily, the apparatus 40 may be camouflaged.

The apparatus 40 includes a water-tight case 44 with a hinge 45 and a gasket 46. Most of the components described above with reference to FIG. 8 are enclosed within the case 44.

The rear side of the apparatus 40 is provided with a V-shaped locking structure 47 including special brackets 48 to facilitate its mounting. The locking structure 47 serves as a portable/moveable locking device for securing the apparatus 40 to an external object, such as tree or post.

The apparatus 40 is provided with a passive infrared sensor 49 and a plurality of infrared emitting diodes 41 and 42. The passive infrared sensor 49 emits a constant signal beam, and senses heat in motion. When this occurs, the passive infrared sensor 49 signals the digital imaging engine 7 to activate the infrared emitting diodes 41 and 42 to illuminate the object and have the color image sensor/camera 53 (sensor 3 in FIG. 9) orient itself in the direction of the object and photograph it. Thus, the passive infrared sensor 49 detects heat in motion, which in turn signals the camera 53 and allows it to take clear photos of the object which is generating the heat in motion

The apparatus 40 also includes a light sensor 52 (FIGS. 10, 11 and 15) which senses the ambient light conditions. The light sensor 52 presets the color image sensor 53 before it “wakes up” for motion activation from the passive infrared sensor 49. The color image sensor 53 thereby already knows the ambient light conditions and has already been pre-focused. This allows for faster trigger speeds and better image quality. For example, when a person walks from inside a dark building and out into bright sunlight, it takes some time to adjust to the sunlight. The sensor 52 does such an adjustment very quickly, for example, in approximately 0.3 tenths of a second.

Preferably, but not necessarily, the apparatus 40 may include a built-in game call identifier 50 (FIG. 15) inside the system which the user can activate from anywhere, such as from a tree stand or elevated location. The sounds may include any desired sounds, such as deer and predator calls.

The system can include the wireless remote RF system so the user can communicate with the apparatus 40 when the user wishes to use or stop the game call. Preferably, but not necessarily, the transmitter 51 (FIG. 15) can be in the form of a wrist watch or a device that attaches to clothing or a hunting apparatus. An inside or outside speaker 60 can be used. Preferably, but not necessarily, the sounds may be stored on the USB jump drive that plugs in to the system, and played back from there through the system.

FIG. 15 shows: the wireless transmitter 51 which is remote from the apparatus 40; a printed circuit board 61 (part of the apparatus 40) having the infrared cluster on/off circuits and switch 43; the light sensor 52 and cluster of diodes 41 and 42.

The transmitter 51 includes the wireless remote game call with pushbutton switches for various calling options, e.g., Buck Grunt Call, Buck Rattling Horns, Doe bleat, one or more Predator calls, etc. These different options are activated by separate buttons 70, 71, 72, 73 which the user can activate separately or as needed. The different sounds are stored on a stored sound device 63, possibly on the USB storage.

The invention is not limited to 24 of each of the diodes 41 and 42, or even to a total 48 diodes.

Also, the invention is not limited to IEDs of a specific wavelength or nano meter.

There have been illustrated in the accompanying drawings and described hereinabove several of the unique and novel embodiments of the present invention which can be practiced and constructed in many different configurations, arrangements of components, sizes, and shapes.

It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention and the patent claims set forth hereinbelow.

1. A self-contained surveillance apparatus, comprising:
a water-tight case;
a 360-degree dome camera mounted in said case;
a digital imaging engine mounted in said case;
a battery supply mounted in said case;
one or more infrared diodes mounted in said case;
one or more passive infrared sensors mounted in said case;
a wireless circuitboard antenna mounted in said case;
a mass storage device mounted in said case;
a day/night exchanger mounted in said case;
a compact flash card mounted in said case; and
said digital imaging engine being operably connected to said camera, said battery supply, said infrared diodes, said passive infrared sensors, said antenna, said mass storage device, said day/night exchanger, and said compact flash card; and
whereby said camera is caused to rotate to face in the direction of an external object to be photographed by said camera.

2. An apparatus according to claim 1, wherein:
said dome camera includes a 360-degree color image sensor;
said color image sensor is operably connected to said day/night exchanger to enable said camera to take true day/night photographic images; and
said images are stored in said mass storage device where they can be viewed and edited when desired.

3. A self-contained surveillance apparatus that does not require remote sensors, comprising:
a water-tight case;
a camera mounted in said case;
a digital imaging engine mounted in said case;
a battery supply mounted in said case;
one or more infrared diodes mounted in said case;
one or more passive infrared sensors mounted in said case;
a light sensor mounted in said case;
a wireless circuitboard antenna mounted in said case;
a mass storage device mounted in said case;
a day/night exchanger mounted in said case;
a compact flash card mounted in said case; and
said digital imaging engine being operably connected to said camera, said battery supply, said infrared diodes, said passive infrared sensors, said antenna, said mass storage device, said day/night exchanger, and said compact flash card; and
whereby said camera is enabled to take a photographic image of an external object entering a heat-in-motion detection zone.

4. An apparatus according to claim 1, wherein:
said infrared diodes comprise a diode cluster including one or more first infrared emitting diodes which emit no visible light and one or more second infrared emitting diodes which emit some visible light.

5. An apparatus according to claim 2, wherein:
said infrared diodes comprise a diode cluster including one or more first infrared emitting diodes which emit no visible light and one or more second infrared emitting diodes which emit some visible light.

6. An apparatus according to claim 3, wherein:
said infrared diodes comprise a diode cluster including one or more first infrared emitting diodes which emit no visible light and one or more second infrared emitting diodes which emit some visible light.

7. An apparatus according to claim 1, including:
a game calling device mounted in said case;
said game calling device includes a speaker through which animal calls can emanate; and
said game calling device can be activated remotely by a wireless transmitter.

8. An apparatus according to claim 2, including:
a game calling device mounted in said case;
said game calling device includes a speaker through which animal calls can emanate; and
said game calling device can be activated remotely by a wireless transmitter.

9. An apparatus according to claim 3, including:
a game calling device mounted in said case;
said game calling device includes a speaker through which animal calls can emanate; and
said game calling device can be activated remotely by a wireless transmitter.

10. An apparatus according to claim 4, including:
a game calling device mounted in said case;
said game calling device includes a speaker through which animal calls can emanate; and
said game calling device can be activated remotely by a wireless transmitter.

11. An apparatus according to claim 5, including:
a game calling device mounted in said case;
said game calling device includes a speaker through which animal calls can emanate; and
said game calling device can be activated remotely by a wireless transmitter.

12. An apparatus according to claim 6, including:
a game calling device mounted in said case;
said game calling device includes a speaker through which animal calls can emanate; and
said game calling device can be activated remotely by a wireless transmitter.

13. An apparatus according to claim 4, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light.

14. An apparatus according to claim 5, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light.

15. An apparatus according to claim 6, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light.

16. An apparatus according to claim 7, including:
circuit switching means electrically connected to said first and second infrared emitting diodes to enable a user of said apparatus to use only said first light emitting diodes which emit no visible light, or to use simultaneously both said first light emitting diodes which emit no visible light and second infrared emitting diodes which emit some visible light.

17. An apparatus according to claim 1, wherein:
said case has a rear side provided with a V-shaped locking structure for releasably and selectively mounting the apparatus to an external structure;
said digital imaging engine controls and signals said day/night exchanger for night and day photographic images;
said digital imaging engine receives signals from external wireless remote sensors; and
said digital imaging engine controls storing said photographic images in said mass storage device or in said compact flash card.

18. An apparatus according to claim 3, wherein:
said case has a rear side provided with a V-shaped locking structure for releasably and selectively mounting the apparatus to an external structure;
said digital imaging engine controls and signals said day/night exchanger for night and day photographic images; and
said digital imaging engine controls storing said photographic images in said mass storage device or in said compact flash card.

19. A surveillance system, comprising:
one or more wireless remote sensors which each send an infrared transmission signal configured into a separate conical array forming a heat-in-motion detection zone;
a surveillance apparatus having a 360-degree dome mounted camera;
wireless transmission means for transmitting a signal from said remote sensor to said apparatus indicative of an external object entering said detection zone; and
means in said apparatus causing said camera to rotate to face in the direction of the object and to photograph the object.

20. A system according to claim 19, wherein said apparatus, comprises:
a water-tight case;
a 360-degree dome camera mounted in said case;
a digital imaging engine mounted in said case;
a battery supply mounted in said case;
one or more infrared diodes mounted in said case;
one or more passive infrared sensors mounted in said case;
a wireless circuitboard antenna mounted in said case;
a mass storage device mounted in said case;
a day/night exchanger mounted in said case;
a compact flash card mounted in said case; and
said digital imaging engine being operably connected to said camera, said battery supply, said infrared diodes, said passive infrared sensors, said antenna, said mass storage device, said day/night exchanger, and said compact flash card; and whereby said camera is caused to rotate to face in the direction of the external object to be photographed by said camera.
